(19) United States
(12) Patent Application Publication
(10) Pub. No.: US 2010/0324254 A1
(43) Pub. Date: Dec. 23, 2010

(54) REACTIVE HOT MELT ADHESIVE

(75) Inventor: Takeaki SAIKI, KANAGAWA (JP)

Correspondence Address: CARRIER BLACKMAN AND ASSOCIATES, 43440 WEST TEN MILE ROAD, EATON CENTER, NOVI, MI, 48375, US

(73) Assignee: THE YOKOHAMA RUBBER CO., LTD., TOKYO (JP)

(21) Appl. No.: 12/795,048

(22) Filed: Jun. 7, 2010

(30) Foreign Application Priority Data
Jun. 18, 2009 (JP) 2009-145607

(51) Int. Cl. C08G 18/34

(52) U.S. Cl. 528/66

(57) ABSTRACT

A reactive hot melt adhesive exhibiting good hardness (flexibility) after curing while maintaining excellent initial adhesion properties is provided. The reactive hot melt adhesive is obtained by reacting a polyether polyol (A), an amorphous polyester polyol (B) having a softening point of less than 40° C., an amorphous polyester polyol (C) having a softening point of 40° C. or more, and a polyisocyanate compound (D).

### TECHNICAL FIELD

The present invention relates to a reactive hot melt adhesive.

Moisture-curable, reactive hot melt adhesives consisting primarily of a polyurethane prepolymer exhibit initial adhesion by cooling and solidification, that is, an adhesive force to fix members together in the initial stage of adhesion, and final adhesion by subsequent curing. In recent years, demand is increasing for such adhesives in terms of environmental response, because they contain no solvent.

Many adhesives obtained by reacting polyether polyol, polyester polyol and the like with polyisocyanate are known as the reactive hot melt adhesives.

For example, JP 2000-53937 A describes a reactive hot melt adhesive comprising an isocyanate group-containing urethane resin and/or amide resin obtained by reacting a mixture of an amorphous polyester polyol (A), a polyether polyol (B) and a tackifier (C) having on average at least one OH group and/or COOH group in one molecule with a polyfunctional isocyanate compound (D).

JP 2003-277717 A describes a reactive hot melt adhesive consisting primarily of an isocyanate group-terminated urethane prepolymer, which is obtained by using polyol components including (1) a polyester polyol obtained from an acid component containing succinic acid as a major component and a diol and (2) a polyester polyol obtained from an acid component containing adipic acid as a major component and a diol component and/or a polyester polyol obtained from an acid component containing phthalic acid as a major component and a diol, the polyester polyol (2) having a melting point lower than that of the polyester polyol (1), and (3) a polyisocyanate.

In addition, JP 2006-104388 A describes a reactive hot melt adhesive composition based on an isocyanate group-terminated urethane prepolymer, wherein the urethane prepolymer comprises a urethane prepolymer component having a crystalline skeleton of a polyester formed by reaction between adipic acid and butanediol and a urethane prepolymer component having a noncrystalline skeleton of a polyester with a glass transition temperature of 25° C. or more at a weight ratio of the former component to the latter component of 1:2 to 2:1.

### SUMMARY OF THE INVENTION

However, it was found that the known reactive hot melt adhesives based on polyurethane prepolymers as described in JP 2000-53937 A, JP 2003-277717 A and JP 2006-104388 A exhibited excellent initial adhesion but had high hardness after curing and may often not follow curves depending on the place where the adhesives were used, thus causing cracking.

Accordingly, an object of the present invention is to provide a hot melt adhesive exhibiting good hardness (flexibility) after curing while maintaining excellent initial adhesion properties.

The inventor of the present invention has made an intensive study to achieve the above object and as a result found that a hot melt adhesive having good hardness (flexibility) after curing while maintaining excellent initial adhesion properties is obtained by using in combination polyester polyols including an amorphous polyester polyol having a softening point of less than 40° C. and an amorphous polyester polyol having a softening point of 40° C. or more. The present invention has been thus completed.

Specifically, the present invention provides the following (1) to (7).

(1) A reactive hot melt adhesive which is obtained by reacting: (A) a polyether polyol; (B) an amorphous polyester polyol having a softening point of less than 40° C.; (C) an amorphous polyester polyol having a softening point of 40° C. or more; and (D) a polyisocyanate compound.

(2) The reactive hot melt adhesive according to (1), which is obtained by reacting the amorphous polyester polyol (B) and the amorphous polyester polyol (C) with a reaction product obtained by reacting the polyether polyol (A) and the polyisocyanate compound (D).

(3) The reactive hot melt adhesive according to (2), which is obtained by mixing the amorphous polyester polyol (B) with the amorphous polyester polyol (C) in advance to obtain a mixture and reacting the mixture with the reaction product obtained by reacting the polyether polyol (A) and the polyisocyanate compound (D).

(4) The reactive hot melt adhesive according to any one of (1) to (3), which is obtained by reacting the polyether polyol (A), the amorphous polyester polyol (B), the amorphous polyester polyol (C) and the polyisocyanate compound (D) so that an equivalent ratio of isocyanate groups of the polyisocyanate compound (D) to all hydroxyl groups of the polyether polyol (A), the amorphous polyester polyol (B) and the amorphous polyester polyol (C) (isocyanate groups/hydroxyl groups) is from 1.05 to 3.0.

(5) The reactive hot melt adhesive according to (4), which is obtained by reacting the polyether polyol (A), the amorphous polyester polyol (B), the amorphous polyester polyol (C) and the polyisocyanate compound (D) so that an equivalent ratio of the isocyanate groups of the polyisocyanate compound (D) to hydroxyl groups of the polyether polyol (A) (isocyanate groups/hydroxyl groups) is from 1.28 to 50.

(6) The reactive hot melt adhesive according to (4) or (5), which is obtained by reacting the polyether polyol (A), the amorphous polyester polyol (B), the amorphous polyester polyol (C) and the polyisocyanate compound (D) so that an equivalent ratio of the isocyanate groups of the polyisocyanate compound (D) to hydroxyl groups of the amorphous polyester polyol (B) (isocyanate groups/hydroxyl groups) is from 1.20 to 180 and an equivalent ratio of the isocyanate groups of the polyisocyanate compound (D) to hydroxyl groups of the amorphous polyester polyol (C) (isocyanate groups/hydroxyl groups) is from 1.20 to 180.

(7) The reactive hot melt adhesive according to any one of (1) to (6), which has recurring units containing at least two isocyanate groups and represented by formulae (1) to (3):

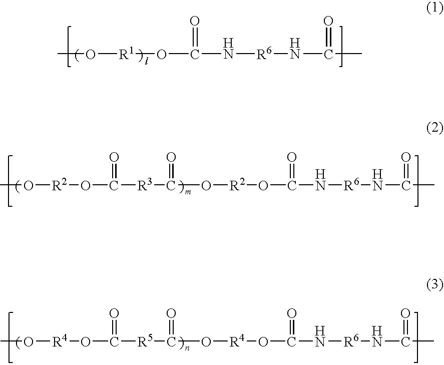

wherein R¹ represents a divalent hydrocarbon group containing 2 to 4 carbon atoms; R², R⁴ and R⁵ each independently represent a divalent hydrocarbon group containing 2 to 20 carbon atoms; R³ represents a divalent hydrocarbon group containing 4 to 20 carbon atoms; and R⁶ represents a divalent hydrocarbon group containing 6 to 20 carbon atoms. l represents an integer of 10 to 300, and m and n each independently represent an integer of 1 to 50. In the respective formulae, a plurality of R¹ to R⁵ groups may be the same or different.

As will be described later, the present invention can provide a hot melt adhesive exhibiting good hardness (flexibility) after curing while maintaining excellent initial adhesion properties.

### DETAILED DESCRIPTION OF THE INVENTION

Next, the present invention is described in detail.

The hot melt adhesive of the present invention is a reaction product obtained by reacting a polyether polyol (A), an amorphous polyester polyol (B) having a softening point of less than 40° C., an amorphous polyester polyol (C) having a softening point of 40° C. or more, and a polyisocyanate compound (D).

Next, the polyether polyol (A), the amorphous polyester polyol (B), the amorphous polyester polyol (C) and the polyisocyanate compound (D) that may be used to produce the hot melt adhesive of the present invention are described in detail.

Polyether Polyol (A)

The polyether polyol (A) is not particularly limited but may be any conventionally known compound used to produce urethane prepolymers.

Examples of the polyether polyol include polyols obtained by adding at least one selected from the group consisting of ethylene oxide, propylene oxide, butylene oxide and polyoxytetramethylene oxide, to at least one selected from the group consisting of ethylene glycol, diethylene glycol, propylene glycol, dipropylene glycol, glycerol, 1,1,1-trimethylol propane, 1,2,5-hexanetriol, 1,3-butanediol, 1,4-butanediol, and pentaerythritol.

More specifically, polypropylene ether diol and polypropylene ether triol are preferably used.

Amorphous Polyester Polyol (B)

The amorphous polyester polyol (B) is an amorphous polyester polyol having a softening point of less than 40° C.

The softening point refers to a temperature measured according to JIS K6863-1994 (method of testing the softening point of hot melt adhesives). The same holds true in the amorphous polyester polyol (C) to be described later.

The amorphous polyester polyol refers to noncrystalline polyester polyol. In the practice of the invention, the amorphous polyester polyol includes one having no definite crystallization or crystalline melting peaks in differential scanning calorimetry (DSC). The same holds true in the amorphous polyester polyol (C) to be described later.

Illustrative examples of the amorphous polyester polyol (B) include condensation polymers of at least one carboxy group-containing component selected from the group consisting of aliphatic dicarboxylic acids such as adipic acid, glutaric acid, pimelic acid, suberic acid, dimer acid, sebacic acid and undecanedicarboxylic acid; alicyclic dicarboxylic acids such as hexahydroterephthalic acid; and aromatic dicarboxylic acids such as phthalic acid, phthalic anhydride, isophthalic acid and terephthalic acid, with at least one hydroxyl group-containing component selected from the group consisting of ethylene glycol, propylene glycol, 1,4-butanediol, pentanediol, 2,4-diethyl-1,5-pentanediol, 3-methyl-1,5-pentanediol, hexanediol, neopentyl glycol, hexamethylene glycol, glycerol, and 1,1,1-trimethylol propane. These may be used alone or in combination of two or more.

Of these, in terms of high compatibility with the polyether polyol (A), a condensation polymer of phthalic acid with 2,4-diethyl-1,5-pentanediol, and a condensation polymer of sebacic acid and isophthalic acid with neopentyl glycol are preferred.

In the present invention, commercial products such as polyester diol (HS2N-226P available from Hokoku Corporation; softening point: 20° C. or less (liquid at 20° C.)) may be used for the amorphous polyester polyol (B).

Amorphous Polyester Polyol (C)

The amorphous polyester polyol (C) is an amorphous polyester polyol having a softening point of 40° C. or more.

Illustrative examples of the amorphous polyester polyol (C) include condensation polymers of at least one carboxy group-containing component selected from the group consisting of aliphatic dicarboxylic acids such as adipic acid, glutaric acid, pimelic acid, suberic acid, dimer acid, sebacic acid and undecanedicarboxylic acid; alicyclic dicarboxylic acids such as hexahydroterephthalic acid; and aromatic dicarboxylic acids such as phthalic acid, phthalic anhydride, isophthalic acid and terephthalic acid, with at least one hydroxyl group-containing component selected from the group consisting of ethylene glycol, propylene glycol, 1,4-butanediol, pentanediol, 2,4-diethyl-1,5-pentanediol, 3-methyl-1,5-pentanediol, hexanediol, neopentyl glycol, hexamethylene glycol, glycerol, and 1,1,1-trimethylol propane. These may be used alone or in combination of two or more.

Of these, in terms of high compatibility with the polyether polyol (A), a condensation polymer of phthalic acid with neopentyl glycol is preferred.

In the present invention, commercial products such as polyester diol (HS2F-306P available from Hokoku Corporation; softening point: 73° C.), polyester diol (HS2F-136P available from Hokoku Corporation; softening point: 70° C.), and polyester diol (HS2F-237P available from Hokoku Corporation; softening point: 80° C.) may be used for the amorphous polyester polyol (C).

Polyisocyanate Compound (D)

The polyisocyanate compound (D) is not particularly limited as long as it has at least two isocyanate groups in the molecule, and may be any conventionally known compound used to produce urethane prepolymers.

Illustrative examples of the polyisocyanate compound (D) include aromatic polyisocyanates such as TDI (e.g., 2,4-tolylene diisocyanate (2,4-TDI), 2,6-tolylene diisocyanate (2,6-TDI)), MDI (e.g., 4,4′-diphenylmethane diisocyanate (4,4′-MDI), 2,4′-diphenylmethane diisocyanate (2,4′-MDI)), 1,4-phenylene diisocyanate, polymethylene polyphenylene polyisocyanate, xylylene diisocyanate (XDI), tetramethyl xylylene diisocyanate (TMXDI), tolidine diisocyanate (TODI), 1,5-naphthalene diisocyanate (NDI) and triphenylmethane triisocyanate; aliphatic polyisocyanates such as hexamethylene diisocyanate (HDI), trimethyl hexamethylene diisocyanate (TMHDI), lysine diisocyanate and norbornane diisocyanate (NBDI); alicyclic polyisocyanates such as trans-cyclohexane-1,4-diisocyanate, isophorone diisocyanate (IPDI), bis(isocyanatomethyl)cyclohexane (H₆XDI) and dicyclohexylmethane diisocyanate (H₁₂MDI); carbodiimide-modified polyisocyanates thereof; and isocyanurate-modified polyisocyanates thereof.

Such polyisocyanate compounds may be used alone or in combination of two or more.

Of these, MDI is preferred in terms of high reactivity, low volatility and low price.

As described above, the reactive hot melt adhesive of the present invention is a reaction product obtained by reacting the polyether polyol (A), the amorphous polyester polyol (B), the amorphous polyester polyol (C) and the polyisocyanate compound (D).

The reactive hot melt adhesive of the present invention has excellent initial adhesion properties and good hardness (flexibility) after curing. Although the details are not clear, this is presumably because the increase in the hardness of the resulting reaction product after curing is suppressed by using the polyether polyol (A) and the amorphous polyester polyol (B) in the reaction, and the initial adhesion strength of the resulting reaction product is improved by using the amorphous polyester polyol (C) in the reaction. More specifically, as will be described in Examples, the reactive hot melt adhesive of the present invention has an initial adhesion strength of about 1 MPa or more and a JIS A hardness after curing of about 70 or less.

This is an unexpected effect because this effect is not obtained in the case described in Example 3 of JP 2000-53937 A, that is, in the reaction product obtained by reacting a polyether polyol corresponding to the polyether polyol (A), a liquid polyester polyol (a crystalline polyester polyol), a polyester polyol corresponding to the amorphous polyester polyol (C), and a polyfunctional isocyanate compound corresponding to the polyisocyanate compound (D).

In the present invention, in terms of the compatibility and yield improvement, the reaction product is preferably obtained by reacting the amorphous polyester polyol (B) and the amorphous polyester polyol (C) with the reaction product (intermediate product) obtained by reacting the polyether polyol (A) and the polyisocyanate compound (D).

In order to make the reaction proceed uniformly, it is particularly preferred for the reaction product to be obtained by mixing the amorphous polyester polyol (B) with the amorphous polyester polyol (C) in advance and reacting the resulting mixture with the reaction product (intermediate product) obtained by reacting the polyether polyol (A) and the polyisocyanate compound (D).

The reaction product is preferably obtained by reacting the components so that an equivalent ratio of isocyanate groups of the polyisocyanate compound (D) to all hydroxyl groups of the polyether polyol (A), the amorphous polyester polyol (B) and the amorphous polyester polyol (C) (isocyanate groups/hydroxyl groups) may be from 1.05 to 3.0.

At the equivalent ratio within the above range, the reactive hot melt adhesive obtained in the present invention has good strength, adhesion properties, curing properties and viscosity during melting.

Likewise, in the present invention, the reaction product is preferably obtained by reacting the components so that an equivalent ratio of the isocyanate groups of the polyisocyanate compound (D) to hydroxyl groups of the polyether polyol (A) (isocyanate groups/hydroxyl groups) may be from 1.28 to 50.

At the equivalent ratio within the above range, the reactive hot melt adhesive obtained in the present invention has good strength, adhesion properties, curing properties and viscosity during melting.

Likewise, in the present invention, the reaction product is preferably obtained by reacting the components so that an equivalent ratio of the isocyanate groups of the polyisocyanate compound (D) to hydroxyl groups of the amorphous polyester polyol (B) (isocyanate groups/hydroxyl groups) may be from 1.20 to 180 and an equivalent ratio of the isocyanate groups of the polyisocyanate compound (D) to hydroxyl groups of the amorphous polyester polyol (C) (isocyanate groups/hydroxyl groups) may be from 1.20 to 180.

At the equivalent ratio within the above range, the reactive hot melt adhesive obtained in the present invention has good strength, adhesion properties, curing properties and viscosity during melting.

The reactive hot melt adhesive of the present invention preferably has recurring units containing at least two isocyanate groups and represented by the following formulae (1) to (3):

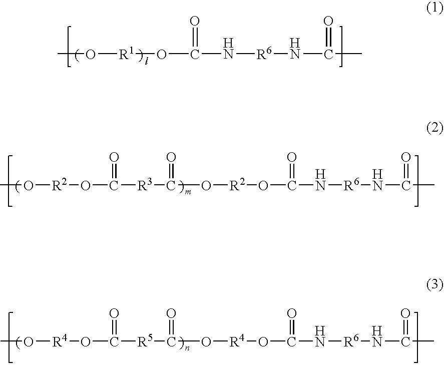

wherein R¹ represents a divalent hydrocarbon group containing 2 to 4 carbon atoms; R², R⁴ and R⁵ each independently represent a divalent hydrocarbon group containing 2 to 20 carbon atoms; R³ represents a divalent hydrocarbon group containing 4 to 20 carbon atoms; and R⁶ represents a divalent hydrocarbon group containing 6 to 20 carbon atoms. l represents an integer of 10 to 300, and m and n each independently represent an integer of 1 to 50. In the respective formulae, a plurality of R¹ to R⁵ groups may be the same or different.

Formula (1) represents a recurring unit obtained by reacting the polyether polyol (A) and the polyisocyanate compound (D).

Illustrative examples of the divalent hydrocarbon group containing 2 to 4 carbon atoms as represented by R¹ include alkylene groups such as ethylene group, propylene group, isopropylene group and butylene group; and vinylene group. A plurality of R¹ groups may be the same or different.

R¹ is preferably propylene group or butylene group.

Illustrative examples of the divalent hydrocarbon group containing 6 to 20 carbon atoms as represented by R⁶ include alkylene groups such as 1,6-hexylene group, 1,7-heptylene group, 1,8-octylene group, 1,9-nonylene group, 1,10-decylene group, 1,11-undecylene group and 1,12-dodecylene group; divalent alicyclic hydrocarbon groups such as 1,4-cyclohexylene group; divalent aromatic hydrocarbon groups such as 1,4-phenylene group, 1,2-phenylene group, 1,3-phenylene group, 1,3-phenylenebis(methylene) group and diphenylmethane-4,4′-diyl group.

R⁶ is preferably diphenylmethane-4,4′-diyl group.

Formula (2) represents a recurring unit obtained by reacting the amorphous polyester polyol (B) and the polyisocyanate compound (D).

Illustrative examples of the divalent hydrocarbon group containing 2 to 20 carbon atoms as represented by R² include alkylene groups such as ethylene group, 1,3-propylene group, 2,2-dimethylpropane-1,3-diyl group, 1,4-butylene group, 1,5-pentylene group, 1,6-hexylene group, 1,7-heptylene group, 1,8-octylene group, 1,9-nonylene group, 1,10-decylene group, 1,11-undecylene group, 1,12-dodecylene group, 2,4-diethylpentane-1,5-diyl group and 3-methylpentane-1,5-diyl group; vinylene group; divalent alicyclic hydrocarbon groups such as 1,4-cyclohexylene group; and divalent aromatic hydrocarbon groups such as 1,4-phenylene group, 1,2-phenylene group, 1,3-phenylene group and 1,3-phenylenebis(methylene) group. A plurality of R² groups may be the same or different.

R² is preferably 2,4-diethylpentane-1,5-diyl group or 3-methylpentane-1,5-diyl group.

Illustrative examples of the divalent hydrocarbon group containing 4 to 20 carbon atoms as represented by R³ include alkylene groups such as 1,4-butylene group, 1,5-pentylene group, 1,6-hexylene group, 1,7-heptylene group, 1,8-octylene group, 1,9-nonylene group, 1,10-decylene group, 1,11-undecylene group and 1,12-dodecylene group; divalent alicyclic hydrocarbon groups such as 1,4-cyclohexylene group; divalent aromatic hydrocarbon groups such as 1,4-phenylene group, 1,2-phenylene group, 1,3-phenylene group and 1,3-phenylenebis(methylene) group. When m is 2 or more, a plurality of R³ groups may be the same or different.

R³ is preferably 1,2-phenylene group or 1,3-phenylene group.

The divalent hydrocarbon group containing 6 to 20 carbon atoms as represented by R⁶ is the same as R⁶ of formula (1).

Formula (3) represents a recurring unit obtained by reacting the amorphous polyester polyol (C) and the polyisocyanate compound (D).

The divalent hydrocarbon group containing 2 to 20 carbon atoms as represented by R⁴ or R⁵ is the same as R² of formula (2). R⁴ is preferably 2,2-dimethylpropane-1,3-diyl group, and R⁵ is preferably 1,2-phenylene group or 1,3-phenylene group.

The divalent hydrocarbon group containing 6 to 20 carbon atoms as represented by R⁶ is the same as R⁶ of formula (1).

The reactive hot melt adhesive of the present invention may be used as a composition optionally containing various additives as long as the merits of the present invention are not impaired.

Exemplary additives include fillers, plasticizers, softeners, adhesion promoters, tackifiers, pigments (dyes), antiaging agents, antioxidants, antistatic agents, flame retardants, stabilizers and solvents.

Fillers in various forms may be used. Illustrative examples thereof include calcium carbonate, magnesium carbonate and zinc carbonate; pyrophyllite clay, kaolin clay and calcined clay; fumed silica, calcined silica, precipitated silica, finely divided silica and fused silica; graphite, metallic powder, talc, zeolite and diatomaceous earth; iron oxide, zinc oxide, titanium oxide, barium oxide and magnesium oxide; carbon black; vinyl chloride paste resin; glass balloons and acrylonitrile resin balloons; fatty acids, resin acids, fatty acid ester-treated products and fatty acid ester urethane compound-treated products thereof.

The content of the filler is preferably from 0.5 to 100 parts and more preferably from 1 to 30 parts with respect to 100 parts of the reactive hot melt adhesive of the present invention.

Illustrative examples of the plasticizer or softener include diisononyl phthalate (DINP), dioctyl phthalate, dibutyl phthalate, dibenzyl phthalate; dioctyl adipate, isodecyl succinate; diethylene glycol dibenzoate, pentaerythritol ester; butyl oleate, methyl acetyl ricinolate, tricresyl phosphate, trioctyl phosphate; adipic acid-propylene glycol polyester, adipic acid-butylene glycol polyester; petroleum-based softeners such as paraffinic oil, naphthenic oil, aromatic oil and liquid polybutene.

The content of the plasticizer or softener is preferably not more than 80 parts with respect to 100 parts of the reactive hot melt adhesive of the present invention.

A silane coupling agent may be used for the adhesion promoter.

Illustrative examples of the silane coupling agent include aminosilane, vinylsilane, epoxysilane, methacrylsilane, isocyanate silane, ketimine silane, or mixtures or reaction products thereof.

Aminosilane is not particularly limited as long as it is a compound having amino group or imino group with a hydrolyzable silicon-containing group, and examples thereof include 3-aminopropyltrimethoxysilane, 3-aminopropyltriethoxysilane, 3-aminopropylmethyldimethoxysilane, 3-aminopropylethyldiethoxysilane, bistrimethoxysilylpropylamine, bistriethoxysilylpropylamine, bismethoxydimethoxysilylpropylamine, bisethoxydiethoxysilylpropylamine, N-2-(aminoethyl)-3-aminopropyltrimethoxysilane, N-2-(aminoethyl)-3-aminopropylmethyldimethoxysilane, N-2-(aminoethyl)-3-aminopropyltriethoxysilane, and N-2-(aminoethyl)-3-aminopropylethyldiethoxysilane.

Illustrative examples of the vinylsilane include vinyltrimethoxysilane, vinyltriethoxysilane, tris-(2-methoxyethoxy)vinylsilane.

Illustrative examples of the epoxysilane include γ-glycidoxypropyltrimethoxysilane, γ-glycidoxypropyldimethylethoxysilane, γ-glycidoxypropylmethyldiethoxysilane, β-(3,4-epoxycyclohexyl)ethylmethyldimethoxysilane, γ-glycidoxypropyltrimethoxysilane, and β-(3,4-epoxycyclohexyl)ethyltrimethoxysilane.

Illustrative examples of the methacrylsilane include 3-methacryloxypropylmethyldimethoxysilane, 3-methacryloxypropyltrimethoxysilane, 3-methacryloxypropylmethyldiethoxysilane, and 3-methacryloxypropyltriethoxysilane.

An illustrative example of the isocyanate silane includes isocyanate propyltriethoxysilane.

An illustrative example of the ketimine silane includes ketiminated propyltrimethoxysilane.

The content of the adhesion promoter is from 0.1 to 10 parts with respect to 100 parts of the reactive hot melt adhesive of the present invention.

Illustrative examples of the tackifier include rosin resins such as rosin ester, polymerized rosin ester and modified rosin; terpene resins such as terpene phenol and aromatic terpene; hydrogenated terpene resins; phenol resins; and xylene resins.

The content of the tackifier is from 1 to 100 parts with respect to 100 parts of the reactive hot melt adhesive of the present invention.

Illustrative examples of the pigment (dye) include inorganic pigments such as titanium dioxide, titanium white, zinc oxide, carbon black, ultramarine blue, red iron oxide, lithopone, lead, cadmium, iron, cobalt, aluminum, hydrochlorides and sulfates; and organic pigments such as azo pigments and copper phthalocyanine pigments.

Illustrative examples of the antiaging agent include hindered phenol compounds and hindered amine compounds.

Illustrative examples of the antioxidant include butylhydroxytoluene (BHT) and butylhydroxyanisol (BHA).

Illustrative examples of the antistatic agent include quaternary ammonium salts; and hydrophilic compounds such as polyglycol and ethylene oxide derivatives.

Illustrative examples of the flame retardant include chloroalkyl phosphate, dimethyl methylphosphonate, bromine/phosphorus compounds, ammonium polyphosphate, neopentyl bromide-polyether and brominated polyether.

Examples of the stabilizer include hindered phenol compounds and triazole compounds.

These various additives may be appropriately used in combination in the composition containing the reactive hot melt adhesive of the present invention.

The method of producing the composition containing the reactive hot melt adhesive of the present invention is not particularly limited, and an exemplary method involves mixing the reactive hot melt adhesive of the present invention and the various additives described above using a roll, a kneader, an extruder or a universal agitator.

The application of the reactive hot melt adhesive of the present invention and the composition containing this adhesive is not particularly limited, but they are useful in adhering headlights, windows and other portions of automobiles to which vibrations are applied, because they retain excellent initial adhesion properties and good hardness (flexibility) after curing.

### EXAMPLES

The present invention is described below more specifically by way of examples. However, the present invention is not limited thereto.

### Example 1

Three hundred grams of polypropylene glycol (EXCENOL2020 available from Asahi Glass Co., Ltd.; number average molecular weight: 2000) dehydrated at 110° C. for 6 hours at a reduced pressure of 1.3 kPa was cooled to 80° C. To the polypropylene glycol was added 108 g of 4,4′-diphenylmethane diisocyanate melted by heating to 80° C., and the mixture was stirred at 80° C. for 24 hours to obtain a reaction product (intermediate product).

Then, to the resulting reaction product (intermediate product) was added a mixture of 300 g of polyester diol (HS2N-226P available from Hokoku Corporation; softening point: 20° C. or less (liquid at 20° C.)) and 200 g of polyester diol (HS2F-306P available from Hokoku Corporation; softening point: 73° C.) that had been previously dehydrated at 110° C. for 6 hours at a reduced pressure of 1.3 kPa, and the resulting mixture was stirred at 120° C. for 1 hour to obtain a reactive hot melt adhesive.

In Example 1, the equivalent ratio of isocyanate groups of the 4,4′-diphenylmethane diisocyanate to all hydroxyl groups of the polypropylene glycol (EXCENOL2020 available from Asahi Glass Co., Ltd.; number average molecular weight: 2000), the polyester diol (HS2N-226P available from Hokoku Corporation; softening point: 20° C. or less (liquid at 20° C.)) and the polyester diol (HS2F-306P available from Hokoku Corporation; softening point: 73° C.) (isocyanate groups/hydroxyl groups) was 1.20.

The equivalent ratio of the isocyanate groups of the 4,4′-diphenylmethane diisocyanate to hydroxyl groups of the polypropylene glycol (EXCENOL2020 available from Asahi Glass Co., Ltd.; number average molecular weight: 2000) (isocyanate groups/hydroxyl groups) was 2.88.

Likewise, the equivalent ratio of the isocyanate groups of the 4,4′-diphenylmethane diisocyanate to hydroxyl groups of the polyester diol (HS2N-226P available from Hokoku Corporation; softening point: 20° C. or less (liquid at 20° C.)) (isocyanate groups/hydroxyl groups) was 3.05, and the equivalent ratio of the isocyanate groups of the 4,4′-diphenylmethane diisocyanate to hydroxyl groups of the polyester diol (HS2F-306P available from Hokoku Corporation; softening point: 73° C.) (isocyanate groups/hydroxyl groups) was 6.43.

### Example 2

Example 1 was repeated except that the polyester diol (HS2F-306P available from Hokoku Corporation; softening point: 73° C.) was replaced by polyester diol (HS2F-237P available from Hokoku Corporation; softening point: 80° C.) and the 4,4′-diphenylmethane diisocyanate was added in an amount of 117 g, thereby obtaining a reactive hot melt adhesive.

In Example 2, the equivalent ratio of isocyanate groups of the 4,4′-diphenylmethane diisocyanate to all hydroxyl groups of the polypropylene glycol (EXCENOL2020 available from Asahi Glass Co., Ltd.; number average molecular weight: 2000), the polyester diol (HS2N-226P available from Hokoku Corporation; softening point: 20° C. or less (liquid at 20° C.)) and the polyester diol (HS2F-237P available from Hokoku Corporation; softening point: 80° C.) (isocyanate groups/hydroxyl groups) was 1.20.

The equivalent ratio of the isocyanate groups of the 4,4′-diphenylmethane diisocyanate to hydroxyl groups of the polypropylene glycol (EXCENOL2020 available from Asahi Glass Co., Ltd.; number average molecular weight: 2000) (isocyanate groups/hydroxyl groups) was 3.12.

Likewise, the equivalent ratio of the isocyanate groups of the 4,4′-diphenylmethane diisocyanate to hydroxyl groups of the polyester diol (HS2N-226P available from Hokoku Corporation; softening point: 20° C. or less (liquid at 20° C.)) (isocyanate groups/hydroxyl groups) was 3.30, and the equivalent ratio of the isocyanate groups of the 4,4′-diphenylmethane diisocyanate to hydroxyl groups of the polyester diol (HS2F-237P available from Hokoku Corporation; softening point: 80° C.) (isocyanate groups/hydroxyl groups) was 4.75.

### Comparative Example 1

Three hundred grams of polypropylene glycol (EXCENOL2020 available from Asahi Glass Co., Ltd.; number average molecular weight: 2000) dehydrated at 110° C. for 6 hours at a reduced pressure of 1.3 kPa was cooled to 80° C. To the polypropylene glycol was added 116 g of 4,4′-diphenylmethane diisocyanate melted by heating to 80° C., and the mixture was stirred at 80° C. for 24 hours to obtain a reaction product (intermediate product).

Then, to the resulting reaction product (intermediate product) was added 500 g of polyester diol (HS2N-226P available from Hokoku Corporation; softening point: 20° C. or less (liquid at 20° C.)) that had been previously dehydrated at 110° C. for 6 hours at a reduced pressure of 1.3 kPa and the mixture was stirred at 120° C. for 1 hour to obtain a reactive hot melt adhesive.

In Comparative Example 1, the equivalent ratio of isocyanate groups of the 4,4′-diphenylmethane diisocyanate to all hydroxyl groups of the polypropylene glycol (EXCENOL2020 available from Asahi Glass Co., Ltd.; number average molecular weight: 2000) and the polyester diol (HS2N-226P available from Hokoku Corporation; softening point: 20° C. or less (liquid at 20° C.)) (isocyanate groups/hydroxyl groups) was 1.20.

The equivalent ratio of the isocyanate groups of the 4,4′-diphenylmethane diisocyanate to hydroxyl groups of the polypropylene glycol (EXCENOL2020 available from Asahi Glass Co., Ltd.; number average molecular weight: 2000) (isocyanate groups/hydroxyl groups) was 3.09.

Likewise, the equivalent ratio of the isocyanate groups of the 4,4′-diphenylmethane diisocyanate to hydroxyl groups of the polyester diol (HS2N-226P available from Hokoku Corporation; softening point: 20° C. or less (liquid at 20° C.)) (isocyanate groups/hydroxyl groups) was 1.96.

### Comparative Example 2

To the mixture of 300 g of polyester diol (HS2N-226P available from Hokoku Corporation; softening point: 20° C. or less (liquid at 20° C.)) and 200 g of polyester diol (HS2F-306P available from Hokoku Corporation; softening point: 73° C.) that had been dehydrated at 110° C. for 6 hours at a reduced pressure of 1.3 kPa, was added 63 g of 4,4′-diphenylmethane diisocyanate melted by heating to 80° C., and the mixture was stirred at 120° C. for 1 hour to obtain a reactive hot melt adhesive.

In Comparative Example 2, the equivalent ratio of isocyanate groups of the 4,4′-diphenylmethane diisocyanate to all hydroxyl groups of the polyester diol (HS2N-226P available from Hokoku Corporation; softening point: 20° C. or less (liquid at 20° C.)) and the polyester diol (HS2F-306P available from Hokoku Corporation; softening point: 73° C.) (isocyanate groups/hydroxyl groups) was 1.20.

The equivalent ratio of the isocyanate groups of the 4,4′-diphenylmethane diisocyanate to hydroxyl groups of the polyester diol (HS2N-226P available from Hokoku Corporation; softening point: 20° C. or less (liquid at 20° C.)) (isocyanate groups/hydroxyl groups) was 1.78, and the equivalent ratio of the isocyanate groups of the 4,4′-diphenylmethane diisocyanate to hydroxyl groups of the polyester diol (HS2F-306P available from Hokoku Corporation; softening point: 73° C.) (isocyanate groups/hydroxyl groups) was 3.75.

### Comparative Example 3

Three hundred grams of polypropylene glycol (EXCENOL2020 available from Asahi Glass Co., Ltd.; number average molecular weight: 2000) dehydrated at 110° C. for 6 hours at a reduced pressure of 1.3 kPa was cooled to 80° C. To the polypropylene glycol was added 95 g of 4,4′-diphenylmethane diisocyanate melted by heating to 80° C., and the mixture was stirred at 80° C. for 24 hours to obtain a reaction product (intermediate product).

Then, to the resulting reaction product (intermediate product) was added 500 g of polyester diol (HS2F-306P available from Hokoku Corporation; softening point: 73° C.) that had been previously dehydrated at 110° C. for 6 hours at a reduced pressure of 1.3 kPa, and the resulting mixture was stirred at 120° C. for 1 hour to obtain a reactive hot melt adhesive.

In Comparative Example 3, the equivalent ratio of isocyanate groups of the 4,4′-diphenylmethane diisocyanate to all hydroxyl groups of the polypropylene glycol (EXCENOL2020 available from Asahi Glass Co., Ltd.; number average molecular weight: 2000) and the polyester diol (HS2F-306P available from Hokoku Corporation; softening point: 73° C.) (isocyanate groups/hydroxyl groups) was 1.20.

The equivalent ratio of the isocyanate groups of the 4,4′-diphenylmethane diisocyanate to hydroxyl groups of the polypropylene glycol (EXCENOL2020 available from Asahi Glass Co., Ltd.; number average molecular weight: 2000) (isocyanate groups/hydroxyl groups) was 2.53.

Likewise, the equivalent ratio of the isocyanate groups of the 4,4′-diphenylmethane diisocyanate to hydroxyl groups of the polyester diol (HS2F-306P available from Hokoku Corporation; softening point: 73° C.) (isocyanate groups/hydroxyl groups) was 2.26.

The resulting reactive hot melt adhesives were evaluated for the initial adhesion properties, state at 20° C. and hardness as described below. The results are shown in Table 1.

Initial Adhesion Properties

Two polycarbonate sheets with a size of 25 mm (length)×50 mm (width)×3 mm (height) were bonded together so that the bonded portion had a size of 25 mm (length)×12.5 mm (width). Each reactive hot melt adhesive obtained was melted by heating to 110° C. and applied to the bonded portion so as to have a thickness in molten state of 1 mm.

A tensile shear test was conducted after cooling at 20° C. for 1 hour and the initial adhesion properties were evaluated.

As a result, a sample with a shear strength of at least 10 N/cm² was rated good as having excellent initial adhesion properties, and a sample with a shear strength of less than 10 N/cm² was rated poor as having inferior initial adhesion properties.

State at 20° C.

The state at 20° C. of each reactive hot melt adhesive obtained was visually checked.

JIS A Hardness

Each reactive hot melt adhesive obtained was melted by heating to 110° C. and poured into a polyethylene cup with a volume of 50 mL and a diameter of 50 mm so as to have a depth of at least 10 mm.

Then, the adhesive in the cup was cooled, solidified and taken out of the cup to be used as a sample for the hardness measurement.

JIS A hardness of the sample was measured at 23° C. according to JIS K6253-1997.

TABLE 1

| | |
|---|---|
| Comparative Example | Example |

| | 1 | 2 | 3 | 1 | 2 |
|---|---|---|---|---|---|
| Initial | Poor | Good | Good | Good | Good |
| adhesion | | | | | |
| properties | | | | | |
| State at | Liquid | Solid | Solid | Solid | Solid |
| 20° C. | | | | | |
| JIS A | 39 | 98 | 95 | 49 | 63 |
| hardness | | | | | |

Table 1 clearly shows that the reactive hot melt adhesive in Comparative Example 1 produced without using the amorphous polyester polyol (C) with a softening point of 40° C. or more had good hardness (flexibility) after curing but was liquid at 20° C. and had poor initial adhesion properties.

It was also revealed that the reactive hot melt adhesive in Comparative Example 2 produced without using the polyether polyol (A) was solid at 20° C. and had excellent initial adhesion properties but that the hardness after curing was too high.

It was further revealed that the reactive hot melt adhesive in Comparative Example 3 produced without using the amorphous polyester polyol (B) with a softening point of less than 40° C. was solid at 20° C. and had excellent initial adhesion properties but that the hardness after curing was too high.

On the other hand, it was revealed that the reactive hot melt adhesives produced using the polyether polyol (A), the amorphous polyester polyol (B) with a softening point of less than 40° C., the amorphous polyester polyol (C) with a softening point of 40° C. or more, and the polyisocyanate compound (D) were solid at 20° C. and had excellent initial adhesion properties and that JIS A hardness after curing was 70 or less and the hardness was therefore good.

What is claimed is:

1. A reactive hot melt adhesive which is obtained by reacting:
(A) a polyether polyol;
(B) an amorphous polyester polyol having a softening point of less than 40° C.;
(C) an amorphous polyester polyol having a softening point of 40° C. or more; and
(D) a polyisocyanate compound.

2. The reactive hot melt adhesive according to claim 1, which is obtained by reacting the amorphous polyester polyol (B) and the amorphous polyester polyol (C) with a reaction product obtained by reacting the polyether polyol (A) and the polyisocyanate compound (D).

3. The reactive hot melt adhesive according to claim 2, which is obtained by mixing the amorphous polyester polyol (B) with the amorphous polyester polyol (C) in advance to obtain a mixture and reacting the mixture with the reaction product obtained by reacting the polyether polyol (A) and the polyisocyanate compound (D).

4. The reactive hot melt adhesive according to claim 1, which is obtained by reacting the polyether polyol (A), the amorphous polyester polyol (B), the amorphous polyester polyol (C) and the polyisocyanate compound (D) so that an equivalent ratio of isocyanate groups of the polyisocyanate compound (D) to all hydroxyl groups of the polyether polyol (A), the amorphous polyester polyol (B) and the amorphous polyester polyol (C) (isocyanate groups/hydroxyl groups) is from 1.05 to 3.0.

5. The reactive hot melt adhesive according to claim 4, which is obtained by reacting the polyether polyol (A), the amorphous polyester polyol (B), the amorphous polyester polyol (C) and the polyisocyanate compound (D) so that an equivalent ratio of the isocyanate groups of the polyisocyanate compound (D) to hydroxyl groups of the polyether polyol (A) (isocyanate groups/hydroxyl groups) is from 1.28 to 50.

6. The reactive hot melt adhesive according to claim 4, which is obtained by reacting the polyether polyol (A), the amorphous polyester polyol (B), the amorphous polyester polyol (C) and the polyisocyanate compound (D) so that an equivalent ratio of the isocyanate groups of the polyisocyanate compound (D) to hydroxyl groups of the amorphous polyester polyol (B) (isocyanate groups/hydroxyl groups) is from 1.20 to 180 and an equivalent ratio of the isocyanate groups of the polyisocyanate compound (D) to hydroxyl groups of the amorphous polyester polyol (C) (isocyanate groups/hydroxyl groups) is from 1.20 to 180.

7. The reactive hot melt adhesive according to claim 1, which has recurring units containing at least two isocyanate groups and represented by formulae (1) to (3): 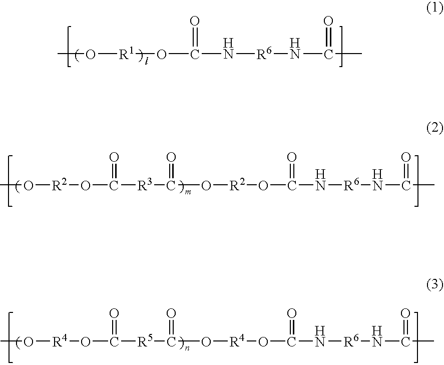
wherein R¹ represents a divalent hydrocarbon group containing 2 to 4 carbon atoms; R², R⁴ and R⁵ each independently represent a divalent hydrocarbon group containing 2 to 20 carbon atoms; R³ represents a divalent hydrocarbon group containing 4 to 20 carbon atoms; and R⁶ represents a divalent hydrocarbon group containing 6 to 20 carbon atoms. l represents an integer of 10 to 300, and m and n each independently represent an integer of 1 to 50. In the respective formulae, a plurality of R¹ to R⁵ groups may be the same or different.
